(19) United States
(12) Patent Application Publication
(10) Pub. No.: US 2016/0104131 A1
(43) Pub. Date: Apr. 14, 2016

(54) SYSTEM AND METHOD FOR EXCHANGING GOODS AND SERVICES

(71) Applicant: COMMUNITY VINES, LLC, State College, PA (US)

(72) Inventor: Kenneth McClelland LAYNG, State College, PA (US)

(21) Appl. No.: 14/894,806

(22) PCT Filed: Jun. 11, 2014
(86) PCT No.: PCT/US2014/041927

§ 371 Date: Nov. 30, 2015

Related U.S. Application Data
(60) Provisional application No. 61/956,654, filed on Jun. 14, 2013.

(51) Int. Cl. G06Q 20/06; G06Q 20/38; G06Q 30/06

(52) U.S. Cl. CPC G06Q 20/0655; G06Q 30/0601; G06Q 20/381

(57) ABSTRACT

A system for implementing an exchange of goods and services for barter currency and volunteer transactions over a computer network includes a server having a processor, memory, storage, a network interface, and remote communications devices for communicating data between the server and the remote communications devices. Each of the remote communications devices is associated with a participating individual. A communications processing module, a barter currency module, a geolocation module, a transaction brokering module, a search engine module, a discovery module, and a database, are provided to process barter currency transactions and volunteer transactions. The barter currency module computes transaction fees, accesses financial accounts metadata and currency distribution metadata, and communicates computation data through a service bus. The barter currency module includes a computation module to send and retrieve data from a financial accounting metadata database and a currency distribution metadata database.

### CROSS-REFERENCE TO RELATED APPLICATIONS

This application claims the benefit of U.S. Provisional Patent Application No. 61/956,654, filed Jun. 14, 2013, entitled “Web-based Barter and Volunteer Currency system,” the disclosure of which is incorporated by reference in its entirety and made part of the present U.S. utility patent application.

### FIELD OF THE INVENTION

The present invention is directed to a system and method for exchanging and soliciting goods and services and for leveraging skills for the good of communities' causes, and members.

### BACKGROUND OF THE INVENTION

Increasingly, people are recognizing that they have become too dependent on unstable institutions and traditions, and are not reliant enough on their fellow citizens and neighbors for the provisioning of goods and services. While bartering and volunteering may be beneficial, it is generally impractical for providers of goods and services to search for, discover, contact, or be contacted by, consumers requiring the respective goods and services, and equally challenging for consumers, looking to barter, to find service providers who need what they have to offer. Existing bartering alternatives have not been able to scale effectively beyond a single community and still maintain a value for local economies. In addition, in bartering communities, alternatives to dollars have not been sufficiently able to scale.

With traditional bartering arrangements, the goods or services must be identified concurrently and/or synchronously in order to complete the exchange. Moreover, goods being exchanged are often not of equal value.

Some barter systems have attempted to address this with multi-party transactions, where the goods and services to be exchanged are identified together and the transaction is executes all exchanges concurrently. This creates additional complexity around the brokering of transactions.

Other barter ecosystems have used a local exchange medium such as a city-wider barter currency or time bank. This approach is problematic because earners of barter currency, or credits, cannot use the currency outside of the specified locality. Existing bartering alternatives have not been able to scale effectively beyond one community while still maintaining a value for local economies. Moreover, alternatives to dollars for bartering have not been sufficiently able to scale.

The present system addresses an industry problem as well as a societal one. Because financial institutions have grown larger and larger, millions of people have come to rely heavily on those institutions and less on themselves and the available resources of their communities for their provision. A significant demand exists for a shift back to reliance on self and local communities for provision of goods and services.

The disclosed exchange system and methods will facilitate a shift to self-reliance and local community economics. The value proposition of such an exchange system and methods actually becomes more compelling and appealing as economic uncertainty increases.

### SUMMARY OF THE INVENTION

With a platform that maintains a closed system consisting of both skills inventories and needs inventories, together with a barter currency and volunteer credit tracking mechanism, the limitations of other attempts at a scalable system are addressed. A member can earn barter credits through exchange in one participating community and transfer or spend those credits in another participating community.

Furthermore the same infrastructure can be used to support both volunteering and fundraising.

The system consists of multiple engines, or software modules, including a brokering engine, a search engine, a discovery engine, and a geolocation engine. In addition, the system includes multiple subsystems and databases. The subsystems include a communication subsystem, a volunteer credits/points subsystem, and a barter currency subsystem. The term engine and module may used interchangeably herein.

To facilitate barter, volunteer, and fundraising transactions, member accounts, profiles, and related data, maintained by the system, function as spokes which interact with and query the hub (the aggregate of metadata and engines comprising the system).

For barter transactions, the barter currency module computes transaction fees, accesses financial accounts metadata, accesses currency distribution metadata, and communicates computation data through a service bus. The barter currency module also includes a computation module to send and retrieve data from a financial accounting metadata database and a currency distribution subsystem.

The currency distribution subsystem references other metadata and handles distribution of currency to and from escrow on behalf of members, and allocation and distribution of fees to multiple types of recipients, including participating financial institutions, other members, and shared revenue pools.

In one embodiment, a method is disclosed for purchasing barter currency and establishing a credit to a purchaser's account in the system.

In another embodiment, a method facilitates the creation of a need posting, the need posting comprising at least a description of a service requested and an initial price; and engaging a provider through the network system to perform the service described in the need posting.

In another embodiment, the disclosed system facilitates a method for brokering (push) and discovery (pull/search) of opportunities for the asynchronous exchange of goods and services using barter currency. The unique nature of the barter exchange is asynchronous, both in terms of time (members can give and receive at different times) and relationship (members can give and receive from different members) for the return side of the transaction.

In an embodiment, the system provides a method for maintaining and supplying members with the accounting documents necessary to comply with the IRS filing rules for their barter activity.

Another embodiment provides a method whereby members, organization members, local governments, and non-profit members—can post needs for volunteering, and make use of the same system and skills inventories to engage volunteers.

This also provides a means for members to build their reputation by earning credibility and ratings which are useful for generating support for engaging in the barter transactions. Members' volunteer activity can be made visible to varying audiences to demonstrate civic engagement, supplementing and creating a more holistic approach to professional profiles. Members may validate their volunteer activity by having an approved, sponsoring non-profit organization certify their time spent in a volunteer activity.

The system is a closed ecosystem that supports commerce and exchange and brokers asynchronous transactions, facilitated by a barter currency and a volunteer tracking subsystem to monetize skills and meet needs. The volunteer tracking subsystem is a hybrid of a volunteer points database used to attribute value and a volunteer time database capable of supporting a robust “volunteer economy.” Whether through assignment in the system or using crowd-sourcing, points may be used to give weight to volunteer contributions, according to the value placed on them by the community. For example, in a given hour, not all volunteer activities may be of equal worth. The volunteer tracking subsystem provides a method whereby higher level skills may become more prevalent in the volunteer economy.

In one embodiment a system is disclosed for implementing an exchange of goods and services through asynchronous barter currency and volunteer transactions over a distributed computer network. The system includes a server that has a processor, a memory module, a storage medium, a network interface, and a plurality of remote communications devices for communicating data between the server and one or more of the plurality of remote communications devices. Each of the remote communications devices is securely associated with a participating individual. The system further includes a communications processing module, a barter currency module, a geolocation module, a transaction brokering module, a search engine module, a discovery module, and a database. The system processes barter currency transactions and volunteer transactions. The barter currency module computes transaction fees, accesses financial accounts metadata, accesses currency distribution metadata, and communicates computation data through a service bus. The barter currency module also includes a computation module to send and retrieve data from a financial accounting metadata database and a currency distribution metadata database.

In another embodiment, a method is disclosed for executing an exchange of goods and services through an asynchronous barter currency and volunteer transaction system. The method includes accessing a distributed data network system for communicating transaction data between a plurality of members; purchasing a barter currency and establishing a credit to a purchaser's account in the system; creating a need posting, the need posting comprising at least a description of a service requested for purchase and an initial price; and engaging a provider through the network system to perform the service described in the need posting.

In still another embodiment, a system is disclosed for implementing an exchange of goods and services through asynchronous barter currency and volunteer transactions over a distributed computer network. The system includes a server having a processor, a memory module, a storage medium, a network interface, and a plurality of remote communications devices for communicating data between the server and one or more of the plurality of remote communications devices. Each of the remote communications is devices securely associated with at least one participating individual, or member. The system further includes a communications processing module, a barter currency module, a geolocation module, a transaction brokering module, a search engine module, a discovery module, and a database. The system processes barter currency transactions and volunteer transactions. The system enables individuals to access a distributed data network system and communicate transaction data between a plurality of members; purchase a barter currency; and establish a credit to a purchaser's account in the system. Also, individuals may create a need posting comprising at least a description of a service requested for purchase and an initial price; and engage a provider through the network system to perform the service described in the need posting.

With a simple and intuitive, yet powerful platform and a non-cash currency used only within the closed system, the disclosed exchange system provides the ability for participating individuals to monetize their respective skills, support fundraising causes, and strengthen their communities through efficient brokering of needs and skills.

The “Eco-system Network” is the top-level network, and consists of all “Community Networks”. The term “eco-system” alone (without modified term “network”) additionally includes all other non-human components such as currency, transactions, member profiles, ratings and reviews, promotions and advertisements, public and shared directories, community-generated standards of practice, etc. The “System” comprises the technical, network, and machine level technologies, devices and protocols.

Community networks are sub-networks, maintained in the community database, consisting of individuals and members, and can be one or more of the following types of sub-networks:

Geographic Communities. Sub-networks defined by the people, groups, and businesses that live and operate within a geographic locale.

Communities of Practice. Sub-networks of people within businesses, defined by common practice, and initiated either by the system or by the member. (e.g. CPAs, dentists, etc.)

Communities of Interests. The people within defined social groups, clubs, hobbyists, etc.

Organizational Communities. People defined by a) SSL-authenticated domains across the network, such as multi-campus universities (psu.edu) or companies (ibm.com) and/or b) existing recognized organizational identifier (existing businesses).

Individual. A person who can engage with the system, whether or not they are a member of the ecosystem. Individuals may be recipients or providers in transactions.

Recipient: An individual, group or organization receiving goods or services in a given transaction.

Provider: An individual, group or organization that provides goods or services in a given transaction. An individual in the exchange ecosystem will function as both provider and recipient at different times. In a given transaction, however, individual or member would take on the role of either recipient or provider.

Depending on how contracts are negotiated, a recipient of work may or may not make payment for service received, and the provider may or may not receive payment. Depending on the combination employed for the transaction, one of three potential scenarios may result: 1) bartering/monetizing skills—when a payment made by the recipient is received by the provider; 2) volunteering—when a payment is not made by the recipient and is therefore not received by the provider; 3) fundraising—when a payment, made by a recipient, is made to a previously defined group or cause, rather than to the provider. The specific scenario is defined at the point of listing or negotiation.

In another embodiment, a method facilitates the creation of contracts between parties to the transaction. Contracts are negotiated through a series of communications and adjustments until such a time as the defined terms are acceptable to both parties, at which time a binding contract is in place. Terms for contracts may include provisions such as scope of work, price, dates for payment, dates for payment schedule and distribution, and split of the transaction fee. Either party in the negotiation may propose contract at any time. Once a proposed contract is accepted by the other party, it becomes a binding contract.

The process of arriving at a binding contract is carried out by the communications subsystem which makes a record of the negotiations as they proceed. Contracts, once in force, continue to be maintained in the communication subsystem until such a time as the contract is completed. Upon completion, contracts are archived in the communications subsystem. Each member maintains access to their contract archives and communication thread.

All transaction messages are logged and time stamped via the communication subsystem from the time of the initial engagement, whether through negotiation, progress through the contract, any disputes, or final ratings and reviews.

In addition to being logged and time-stamped, ratings and reviews may become usable elements for public display, incorporation into profiles, and may further be leveraged with indirect (2^{nd} degree, 3^{rd} degree etc) connections to further establish trust.

The system tracks various relationships between people and business in the ecosystem, to enable leveraging of indirect connections (2nd/3rd degree) in order to facilitate trust. This establishes a means by which members can select candidates for exchange who are not too far removed from other people they know in the community. It also provides a means of obtaining references prior to contracting for work.

Transactions can be initiated from any “direction”: 1) by a provider of services seeking a member with a posted need, whether for barter or volunteer, 2) by a member who has posted a need, seeking a provider, whether for barter or volunteer, or 3) as a cause, on behalf of a member, seeking to enlist the support of those who can contribute their time and skills in support of the cause.

The exchange system addresses various problems for different customer segments. For a participating individual with skills to offer, it provides the ability to monetize those skills with limited commitment to long-term employment or contracts. For example, students can meet needs without having to commit to a regular or ongoing schedule. Senior citizens can supplement their fixed incomes with their vast experience and knowledge.

For a participating individual that requires skills of others, e.g., labor or knowledge workers, the system provides a means to obtain those skills from people and easily exchange services. For participating individuals that are service-minded, the system provides a way to discover opportunities to organize and serve in a social context. For participating organizations, e.g., non-profit entities, the system incentivizes participating individual to volunteer and provides a means of promoting needs within the community. For local governments, the system can helps to defray costs and keep taxes lower by generating volunteer support for civic needs.

In another embodiment, a method leverages the computation engine together with volunteer tracking via the time/points subsystem to build and promote incentivizes for active volunteers to look first for opportunities to give their time to recipients who have, themselves, been active volunteers. More weight, via points, is awarded for giving to those who have given. This can become a means of complimenting other systemic approaches to long-term provisions such as Social Security and can support values such as aging in place.

The underground economy in the United States accounts for an estimated $2 trillion per year—roughly 13% of the Gross Domestic Production (GDP). As confidence in the global and national economy has faltered, participation in this underground economy has consistently escalated. Assuming two-thirds of this market activity consists of legal transactions, a Social Accounting Matrix (SAM) exists on the order of approximately $1.3 trillion. (Source: “America's Underground Economy”, archived at http://mpra.ub.uni-muenchen.de/29672)

As fractions of this market are captured through the system, the need to raise taxes is decreased as activity, previously unreported, is captured. Members will generally be happy to pay tax on transactions that are so deeply discounted by virtue of these exchanges, skill for skill.

The present method and system provides the framework to expand the SAM and document what are currently unreported or off-balance sheet transactions with a trusted, compelling and convenient web-based social framework. With the ability to capture currently unreported or off-balance sheet transactions and derive revenue accordingly, the tax revenue benefit to government is clear. A benefit to members and communities is provided because governments can post needs for volunteering and thereby provide for community needs without the need to increase taxes. Further, with the opportunities afforded by the present invention, and the additional tax revenue stream, at the same time that there is actually a disincentive for an increase of taxes, there is an incentive to volunteer for local governments.

The following is a list of advantages and features disclosed herein:

A method to provide for asynchronous barter transactions using a barter currency.

A method for additionally facilitating and incentivizing volunteering activities.

A method for additionally facilitating fundraising activities.

A method for facilitating a terms negotiation process to arrive at a binding contract.

A method of enabling an escrow service in a skills-goods-needs exchange framework.

A method to facilitate ratings, reviews, and endorsements to establish confidence in barter and volunteer transactions.

A method to establish a system whereby groups can be created and used to engage as single parties to barter and volunteer transactions.

A method for leads generation in a barter and volunteer system, based on a cross-referencing of a) member-defined goods and skills, and b) member-defined needs.

A method for maintaining transaction history—whether barter or volunteer—for the purpose of provisioning reports for member tax filings.

A method for tying in to public records and leveraging 3rd-party APIs in order to report background check information on members so parties to a transaction can establish trust and confidence of other members. This could be requested or volunteered by any party to a transaction during the contract negotiation stage.

A method for the creation of trust directories that can be published publicly or privately shared between members.

A method whereby a scaled system facilitates the use of barter currency outside of a single locale, and in any participating location nationwide, or even worldwide.

A method that facilitates the ability to serve in one community and have the reciprocal service come back to another member (e.g. aging parent) in another community.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary architecture of a barter exchange system.

FIGS. 2A and 2B show an exemplary user case.

FIGS. 3A and 3B show an exemplary barter process flow diagram corresponding with the user case of FIGS. 2A and 2B.

### DETAILED DESCRIPTION OF THE INVENTION

The exchange system and method discloses a framework that establishes a comprehensive, scalable, online ecosystem. The ecosystem describes a network of networks within a closed system which comprise a marketplace, locale, and/or community, e.g., an economic region, group of people, or other predefined unit—and includes all stakeholders such as suppliers, participating members or individuals, customers, prospective customers, and related parties. The exchange system establishes a means of cultivating relationships where trust can be established and needs can be identified and met. To achieve this, the disclosed exchange system provides a mechanism that allows participating individuals to purchase, earn and store barter currency for goods or services provided by an individual, and to apply that barter currency towards other goods or services through the exchange system at a later time, from any other member. The exchange system addresses the primary weaknesses of traditional barter systems through 1) “bankability” of its barter credits, 2) scalability to process an ever increasing number of transactions, and 3) mobility.

The exchange system makes bartering as easy as a cash transaction. It establishes a means to support local economies by converting three resources—1) time, 2) expertise and 3) dollars—into an alternate currency. Using computer hardware and software, and a social framework, the exchange system establishes a robust barter and volunteer economy, outside of a dollar-based currency system where members can discover providers and opportunities based on their unique needs and skills sets. Related opportunities are communicated to participating individuals or users through electronic notifications. With a full-featured mobile wireless platform, participating individuals, or members, may offer goods and services and secure engagements easily from anywhere at any time. In addition, the exchange system captures what are otherwise unreported transactions.

The system incentivizes and promotes volunteer activities, thereby strengthening member communities by facilitating higher level skills in the volunteer economy.

The exchange system establishes initial trust in its alternate currency through backing from the dollar and community relationships. In one embodiment an exchange rate, e.g., initially 1:1 between the dollar and the barter currency may be established. Trust between members may be established through ratings, reviews, and endorsements of and by other members, and optionally through a third party identity verification service, integrated by way of an API.

In one preferred embodiment the exchange system may be a closed system, or data network, of commerce and exchange that brokers asynchronous transactions facilitated by a barter currency, to monetize skills and meet needs.

The network is divided into sub-networks, or communities wherein the boundaries of a marketplace are defined. The four types of communities enable the establishment and maintenance and support of local economies while also enabling inter-community connectedness, e.g., for portability of transactions between communities, or for transacting business between communities.

A transaction is done to a) monetize, b) volunteer, or c) support a “cause.” Monetization and support of causes both involve payment from the recipient of the goods or services. With causes, the payment is just made to a third-party. For example, in the case of a given cause, members throughout the community could engage in multiple separate and distinct transactions, all oriented toward support of that single cause.

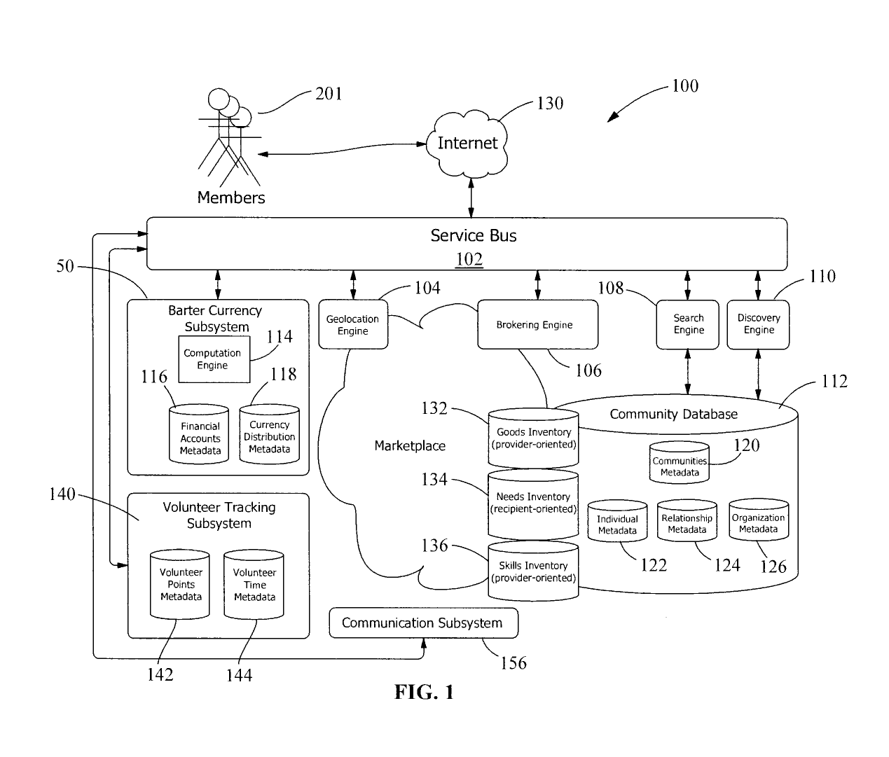

The exchange system further includes a volunteer module or volunteer tracking subsystem (FIG. 1). The volunteer module leverages the same infrastructure and skill repositories, but will broker volunteer transactions rather than barter transactions. Volunteer transactions may be used, e.g., to build a participating individual's reputation within the system and respective community, and to further support and enable activity in the monetization side of the system. Tracking of volunteer activities can also be used to incentivize volunteer activity from other members in the community. The volunteer module records and tracks all history of a participating individual's volunteer activity, and optionally (at the member's discretion), displays volunteer records of the participating individual to the public or for visibility within defined member directories.

In one disclosed embodiment, a participating individual establishes an account, preferably at no cost to the participating individual. A mobile application (app) may be downloaded to a mobile computing device, e.g., a smartphone, iPad, notebook PC, or similar mobile computing device, also preferably at no cost to the participating individual. With full mobile functionality, any member may communicate with the exchange system computer network at any time from any location.

In one exemplary monetizing embodiment, a participating individual may be a landlord with an emergency at one of the participating individual's rental properties while the participating individual happens to be out of the area. Using a smartphone, the participating individual may log into the system, search the participating individual database, and identify all participating members having the necessary goods and services, e.g., carpentry skills, who may be online in their exchange system community at the moment the carpentry service is requested. The participating individual may select a provider, e.g., a participating individual having a strong user rating or feedback score, send a message to the provider participating individual, e.g., via instant message or SMS, and negotiate terms of a barter transaction—all while the landlord is in transit. In this example the individual may request a monetize option; alternately, if the provider was so inclined, the parties could agree that payment be made to support an existing cause defined in the system. Upon completion, the provider of service is paid with “barter currency” rather than dollars, thereby 1) conserving recipient's dollars for “dollar only” transactions (e.g. mortgage, utilities, etc.) and 2) achieving resolution without the constraints of a typical B2C framework (e.g., typical hours of operation).

Then, at a later time, the carpenter receiving the barter currency in exchange for carpentry services provided to the landlord may apply his barter currency to 1) engage other members in the community for their services, or 2) transfer the barter currency to another member, or 3) convert the earned barter currency to cash. Members can store their barter currency in the system and spend their barter currency in any participating community. In an alternate embodiment, members of one community may transfer barter currency and volunteer credits to another community, along with their membership. Transfers between communities and conversion of barter currency to cash may incur a charge to the member, in order to provide incentives for members maintain communities.

By using geotracking functionality in their respective smartphones members may also identify barter or volunteer opportunities within the exchange system. The member that posts the need may define the location, and the system, using existing mapping technology and APIs, provides directions.

Referring next to FIG. 1, an exemplary architecture of exchange system 100 is shown. A service bus 102 controls communications between connected elements in system 100. Service bus 102 provides infrastructure for network communication, event distribution, naming, and service publishing, and interconnectivity or system resources, engines and databases. Service bus 102 may provide, e.g., connectivity options for Application Program Interfaces (API) and various system components. For example, service bus 102 may monitor and control routing of messages between services, and resolve communicating service conflicts, as well as other network services.

Service bus communicates with barter currency subsystem 50; volunteer tracking subsystem 140; geolocation engine 104; a brokering engine 106; a search engine 108; and a discovery engine 110. Barter currency subsystem 50 includes a computation engine 114 that handles computing transaction fees. Barter currency subsystem 50 also includes a financial accounting database 116 for storing financial accounts metadata, and a currency distribution database 118 for storing currency distribution metadata. Computation engine 114 sends and retrieves data from financial accounting database 116 and currency distribution database 118 for performing barter currency transactions, and communicates computation data to other network-connected devices through service bus 102. The currency distribution database 118 includes the collection of data and metadata which is used in calculating the amounts to be allocated or distributed when currency is transferred. Examples of this kind of data would be the fee rates for transactions occurring within a community, across community boundaries for various source and destination communities, as well as percentages of the fees that are distributed to external revenue sharing pools. Financial accounts database 116 includes the collection of data and metadata dealing with financial accounts assigned to individuals and organizations as well as dividend and distribution pools used and reserved for various purposes.

Volunteer tracking subsystem 140 handles computing and storing volunteer transaction terms in volunteer points metadata database 142, and volunteer time metadata database 144.

Geolocation engine 104 provides services to the platform to answer location-based questions relating to geography, e.g., to map mailing addresses of individuals and organizations to a physical location for the purpose of assigning them to physical location-based communities, or the location of a user's mobile communication device such as a cell phone or portable computer. Geolocation information is communicated by geolocation engine to service bus 102 for use by other services, e.g., web services, on system 100, as described in greater detail below.

Service bus 102 is also in data communication with a brokering engine 106, a search engine 108, and a discovery engine 110. Brokering engine 106 is a collection of components implementing the functionality that carries out the asynchronous transactions that occur within system 100. Search engine 108 provides services to the platform for querying information in associated databases about communities and related individuals/organizations within the communities. Discovery engine 110 is a specialized collection of components that perform data mining and metrics-gathering for the platform. The discovery engine performs functionality such as pushing notifications to individuals about others that may have a need or skill of interest by the individual. The discovery engine may also be configurable to generate recommendations to Individuals and organizations within communities based on data that is mined from the community database.

Search engine 108, and discovery engine 110 exchange data with a community database 112. The community database stores data and metadata that make up communities, e.g., metadata about individuals, metadata about businesses and organizations, the various relationships between the individuals and organizations, as well as the communities that these entities are aggregated into. In one embodiment community database 112 includes communities metadata 120 including data about communities. Each community that exists and functions within the system 100 may be uniquely identified and stored in community database 112. Descriptive data about a community, metrics, and the activity that occurs within a community is all considered to be community metadata 120.

Individual metadata 122 consists of the data associated with registered users. Individuals' metadata 122 is data about individual people. Any individual that exists and interacts (actively or passively) with the platform may be uniquely identified and stored in community database 112. Individual profile data, skills, needs, ratings, endorsements along with metrics and activity are all considered to be individual metadata 122. Relationship metadata 124 includes data that describe relationships between various members and communities. Individuals and organizations within the community database have relationships amongst one another. The nature of these relationships and metadata about the relationships may be stored and maintained within the community database. Examples of this metadata might be individuals who are family members, friends, colleagues, customers, clients, patients, students/teachers, etc. Organization metadata 126 includes metadata associated with various participating organizations. Organizations metadata 126 is the data about organizations, whether they are business organizations, professional organizations, interest-based organizations, or some other group of individuals.

In addition to community database 112, additional data storage associated with the marketplace 130 includes a goods inventory database 132, a needs inventory database 134, and a skills inventory database 136. Goods inventory database 132 is provider-oriented and contains information regarding available goods for barter transactions. Goods inventory database includes a directory of all physical goods that are being offered by individuals who wish to take part in transactions within system 100. Needs inventory database 134 is recipient oriented, and contains information regarding goods and services desired or sought by users. Needs inventory database 134 is a directory of all needs that individuals and organizations have within their respective communities. Skills inventory database 136 contains The skills inventory is a directory of all skills that individuals and organizations have to offer within their respective communities.

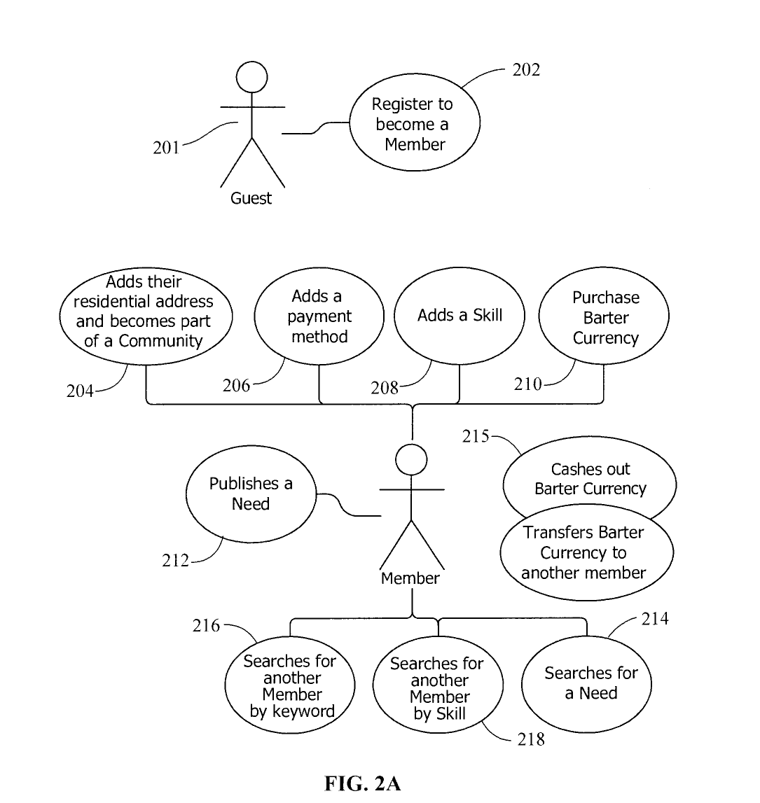

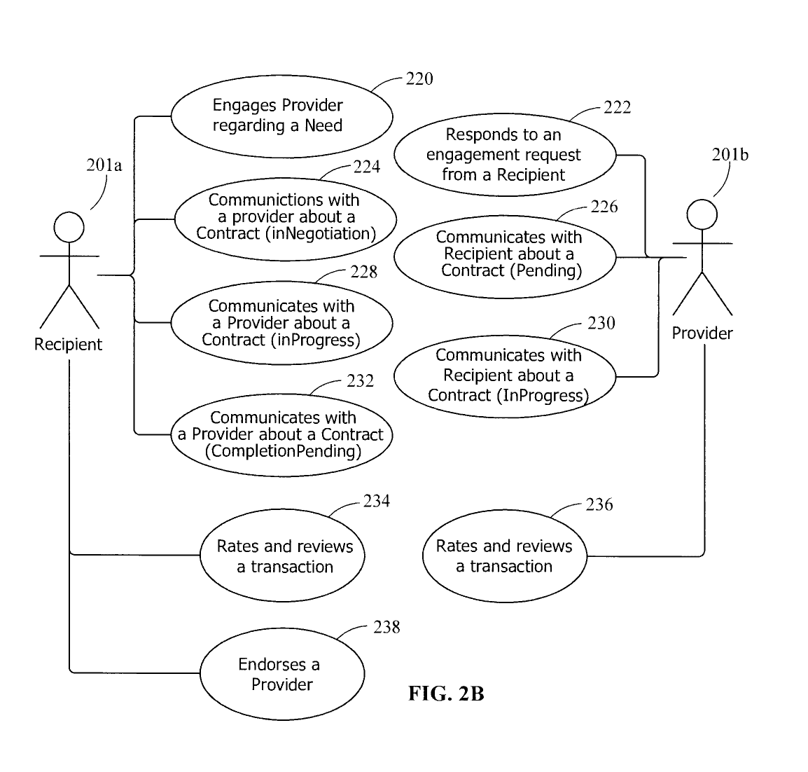

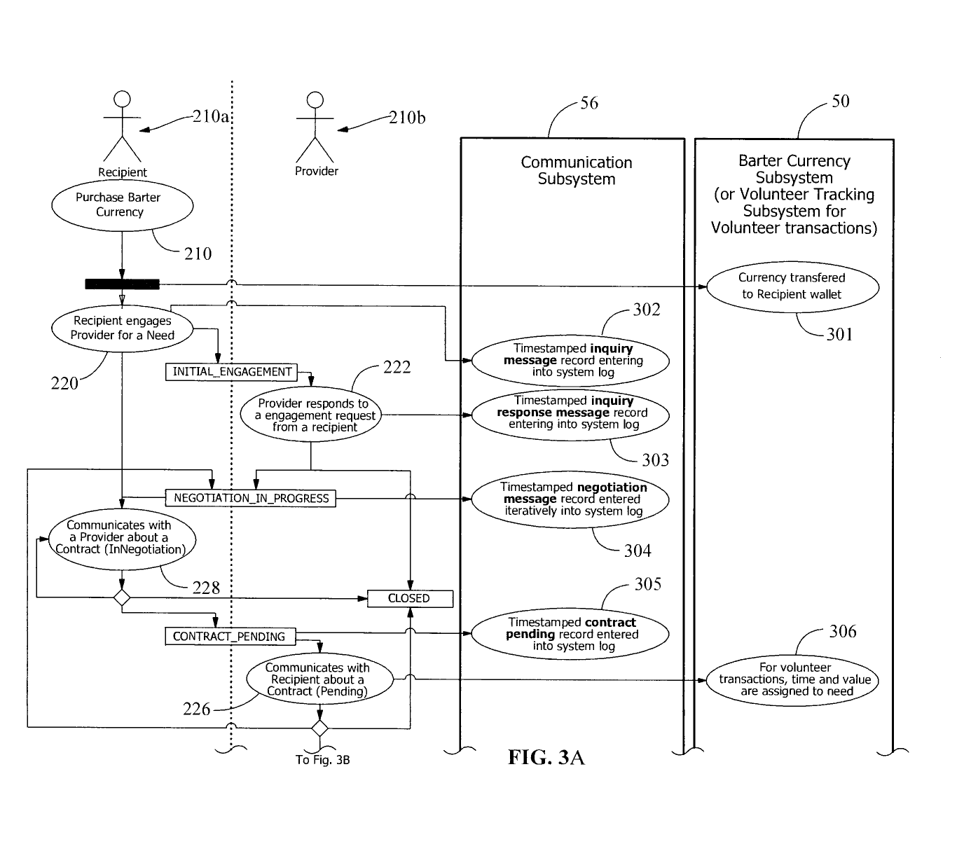

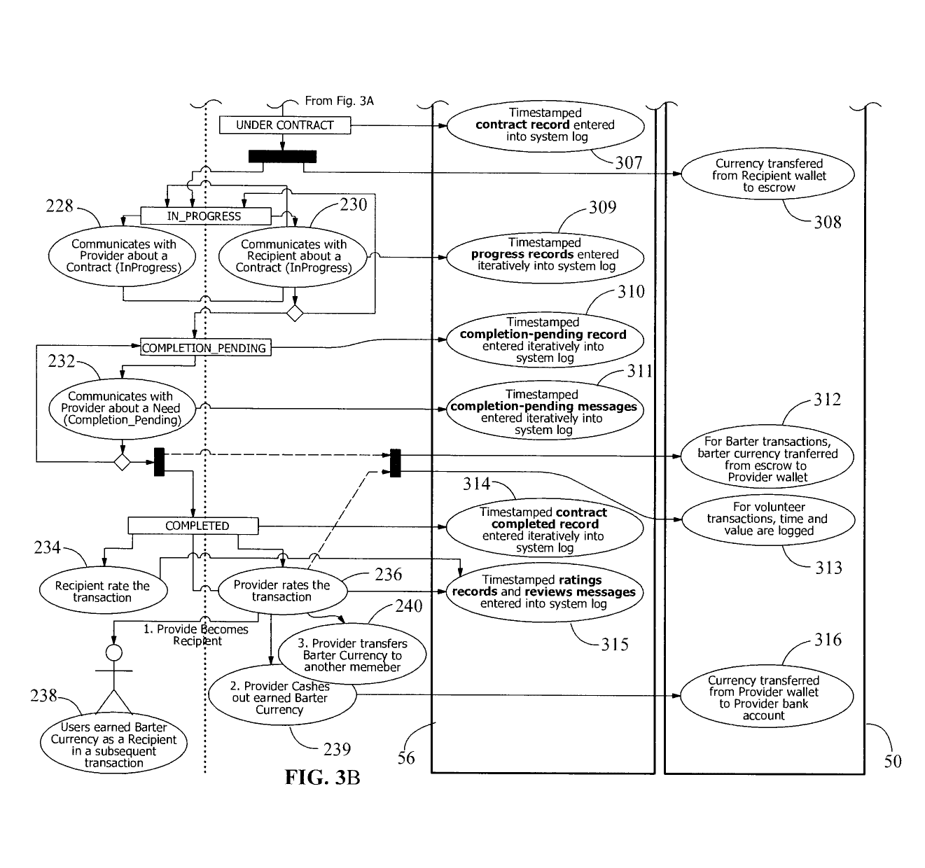

Referring next to FIGS. 2A, 2B, 3A and 3B, an exemplary user case 200 is provided for illustration of barter currency system 100. Initially, at step 202 a user accesses system 100, e.g., via the Internet or private network, and initiates a registration process to become a member. The use may be prompted by system 100 to enter identification criteria, e.g., email address, first and last name, desired username, and a desired security password, and optionally additional profile information. At step 204, once registered, member 201 becomes part of a community, based on geolocation information or other community authentication criteria. At step 206 member 201 inputs payment methods, e.g., credit or bank account information to be debited or credited based on barter currency transactions executed by system 100.

Next, at step 208, member 201 may add a skill that member 201 is able to personally provide to other members or organizations. At step 210, member may purchase barter currency for use in barter currency system 100. At step 212 member 201 may enter a need posting if member wishes to receive services. Member 201 may enter a title for a need posting including a description of the need posting consisting of details such the services required, scope and duration of a need. Member then enters an initial negotiation price, together with other proposed transaction variables, and submits the need posting to system 100. System 100 compares the initial price of the need posting with the amount of barter currency in the member's wallet. If member 201 does not have enough currency balance equal to or greater than the initial price of the need posting, a message is returned to member 201 with an offer to purchase the barter currency required to engage in the transaction. If member 201 does have sufficient barter currency in the member's wallet to cover the initial price of the need posting, the need posting is created.

In order for member 201 to purchase barter currency member 201 must have at least one payment method configured for system 100. Member 201 chooses the amount of barter currency to purchase for credit to member's wallet. System 100 determines the cost and availability of the submitted amount. If the amount of barter currency is available to be purchased through system 100, the corresponding price for the purchase is returned to member 201. If member 201 chooses to proceed with the purchase of barter currency, system 100 processes the payment. After payment processing, the amount of barter currency purchased is transferred from the proper account into the wallet of member 201 by the barter currency subsystem at step 301.

At step 212, member 201, with a profile with a valid email address, may create a need posting as a recipient. All need postings become searchable and publicly viewable within the community, or according to the publishing member's defined scope of visibility, and appear in a listing in recipient's user interface. The recipient enters a description of the need posting consisting of details such as scope and duration. Recipient also enters an initial negotiation price and submits the need posting. System 100 then compares the initial negotiation price of the need posting with the amount of barter currency in the recipient's wallet. If the recipient has sufficient barter currency to cover the initial negotiation price, the need posting is created. This is verified upon initiation of negotiation of a transaction and corresponding amount is escrowed with system 100 upon the creation of a binding contract.

At step 214, a member 201 may search for a need posting as a searcher. A searcher initiates the need posting search flow by entering a string into an input field which is configured for need posting search. The searcher then submits the search. The search service processes the text input, determines the most relevant need postings, and returns the search results. In the search results the searcher is presented with a list of need postings from the search service.

At step 216, a member 201 may search for another member by using, e.g., a keyword or search term. Member 201, as a searcher, initiates the member search flow. A searcher enters a string into an input field which is configured for member search. The searcher submits the search. The search service processes the text input, determines the most relevant Members based on member profile, and returns the results. Member 201 is presented with a list of member profiles from the search service.

At step 218, member 201 may search for other members by skill and obtains a list of search results. A search service processes the text input, determines the most relevant members based on skills, and displays a list of member profiles.

An exemplary transaction may be completed according to the following process. At step 220, recipient engages provider for a need through system 100. Recipient initiates an engage provider workflow. Recipient sends a notification the provider containing, e.g., a reference to the provider, a reference to the need posting, and the initial engagement message from the recipient. A need is then created in system 100 with a status of INITIAL_{—} ENGAGEMENT. While the exemplary transaction illustrated in FIGS. 2A and 2B shows a recipient initially engaging a provider, a provider may also initially engage a recipient in response to needs posted by recipients. At that time in the communication subsystem 56 a timestamped inquiry message record 302 is entered into the communications subsystem log.

At step 222, a provider responds to an engagement request from a recipient. Provider initiates respond to engagement request workflow. Provider sends a message to the recipient to begin discussing the need. A notification is sent to the recipient with the message entered by the provider. At that time in the communication subsystem 56 a timestamped response message record 303 is entered into the communications subsystem log. The need is updated with a status of NEGOTATION_IN_PROGRESS. At that time in the communication subsystem 56 a timestamped negotiation message record 304 is entered into the communications subsystem log. A notification is then sent to the recipient with the message entered by the provider and the need is updated with a status of CLOSED.

At step 224, recipient communicates with a provider about a contract that is under negotiation, and recipient initiates a workflow. Recipient may send a message to the provider to communicate details related to the need. Recipient is presented with user screen, or interface, allowing the recipient to set or change the parameters of the negotiation. If recipient activates CLOSE, the need is updated with a status of CLOSED. A notification is then sent to the provider with the message entered by the recipient. If recipient activates SEND the need is updated with the latest parameters from the negotiation parameters interface. A notification is sent to the provider with a message entered by the recipient. If recipient activates PROPOSE-FINAL-TERMS, the need is updated with the latest parameters from the negotiation parameters UI. The need is updated with a status of CONTRACT_PENDING. At that time in the communication subsystem 56 a timestamped contract pending message record 305 is entered into the communications subsystem log. A notification is then sent to the provider with the message that was entered by the recipient.

At step 226, provider communicates with recipient about a contract (pending). Provider initiates a communication about contract pending workflow. At step 226, for volunteer transactions, barter currency subsystem 50 assigns a time and value to the associated need 306. Service provider 201b is presented with a READ-ONLY view of the current negotiation parameters of the need. Provider is then presented with a textbox allowing provider to type a message to the recipient to communicate about the current negotiation parameters of the need. The need is updated with a status of UNDER CONTRACT at step 307 by communication subsystem 56. Also, barter currency system 50 transfers barter currency from recipient wallet to an escrow at step 308.

If provider activates CLOSE, the need is updated with a status of CLOSED. A notification is then sent to the recipient with the message entered by the provider. If provider activates REJECT-FINAL-TERMS, the need is updated with a status of NEGOTIATION_IN_PROGRESS. A notification is then sent to the recipient with the message entered by the provider. If provider activates ACCEPT-FINAL-TERMS, the need is updated with a status of IN_PROGRESS. The barter currency is then transferred from the recipient's wallet and into escrow and a notification is sent to the recipient with the message entered by the provider.

At step 228, recipient communicates with provider about a need (in progress). Recipient initiates communicate with provider about need in progress workflow. Recipient is presented with a textbox allowing the recipient to enter a message to the provider to communicate about the progress of the need. A notification is then sent to the provider with the message entered by the recipient. Communications subsystem 56 enters timestamped progress records iteratively into the system log at 309.

At step 230, provider communicates with recipient about a need (in progress). Provider initiates communicate with recipient about need in progress workflow. Provider is presented with a textbox allowing the provider to enter a message to the recipient to communicate about the progress of the need. A notification is then sent to the recipient with the message entered by the provider. The need is updated with a status of COMPLETION_PENDING. A notification is then sent to the recipient with the message entered by the provider. Communications subsystem 56 enters timestamped completion pending records iteratively into the system log at 310.

At step 232, recipient communicates with provider about a need (completion pending). Communications subsystem 56 enters timestamped completion pending records iteratively into the system log at 311. If recipient initiates communication with provider about job completion, recipient is then presented with a textbox allowing the recipient to enter a message to the provider to communicate about the completion of the need. A notification is then sent to the provider with the message entered by the recipient. If recipient activates ACCEPT-JOB-COMPLETION, the need is updated with a status of COMPLETED. Communications subsystem 56 enters timestamped completed record iteratively into the system log at 314. Barter currency subsystem 50 transfers the escrow to provider's wallet at 312. Alternately, at 313, barter currency subsystem 50 logs time and value information for volunteer transactions. A notification is then sent to the provider with the message entered by the recipient.

At step 234, member 201a rates a transaction as a recipient. Member (recipient) initiates rate transaction as recipient workflow. Recipient chooses a rating score, e.g., from 1 to 5 across one or more variables of service. Rating from the recipient for the transaction is then stored and sent to the scoring service for scheduling an update to the provider's score.

At step 236, member 201b rates a transaction as a provider. Member (provider) initiates rate transaction as provider workflow. Provider chooses a rating score, e.g., from 1 to 5 across one or more variables. Rating from the provider for the transaction is then stored and sent to the scoring service for scheduling an update to the recipient's score. Communications subsystem 56 enters timestamped ratings records and reviews into the system log at 315.

At step 238, provider receives barter currency from the recipient and uses barter currency received in subsequent transactions as a recipient; or, at 239, cashes out barter currency from provider's account, or at 240, transfers barter currency to another member. Barter currency subsystem 50 transfers currency to provider bank account from provider wallet when cashing out barter currency, less any applicable costs.

TABLE 1

| 3 Use Cases | | |
|---|---|---|
| for the System: | Provider | |
| Recipient | Receives Payment | Payment Not Received |
| Makes Payment | 1. Barter | 2. Causes, Fundraising |
| | | (Payment made to someone other |
| | | than Recipient) |
| Does Not Make | N/A | 3. Volunteering |
| Payment | | |

Table 1 describes an exemplary transaction results table describing transactions in system 100. By way of negotiation, a recipient of goods or services either makes payment or does not make payment. Similarly, by way of negotiation, a provider of goods or services either receives payment or does not receive payment. Using the various combinations that result, and differing combinations of architecture elements within the system, there are three possible applications. They are as follows:

Bartering occurs when a recipient in a transaction makes payment in barter currency and the corresponding provider, either directly or indirectly, receives payment for the transaction by way of the barter currency subsystem (FIG. 1).

Volunteering occurs when a recipient in a transaction does not make payment and the provider in the corresponding transaction does not receive payment. In these cases, the time given and received, together with volunteer points assigned are maintained by the system for the members.

Fundraising occurs when a recipient in a transaction makes payment, but the provider does not receive payment. In these cases, payment is made to a third-party (according to currency dist metadata) which was defined in advance within the system.

The type of transaction—barter, volunteer or fundraising—is defined a) during the negotiation process, or b) at the time of the posting of the need.

### DEFINITIONS

Recipient: A member group, business or non-profit that receives goods or services in a transaction.

Contract: A contract is a binding agreement between a recipient and a provider to transact goods or services in exchange for barter currency, or, in the case of volunteering, time.

Member: A member 201 is a person who has successfully established an account in the system.

Endorsement: An endorsement is a piece of text submitted by a recipient which contains informative data regarding a provider. An endorsement is not specific to any particular transaction between a recipient and a provider, but requires at least one transaction has taken place between the recipient and the provider.

Guest: A guest is anybody who uses the community website without being logged in.

Member profile: A member profile is the collection of all information associated with a member. Some of this information is private (examples: barter currency balance) while other information is public (examples: skills, endorsements, rating). Still other information may be made public at the option of the member.

Negotiation: A negotiation is the phase of an interaction between a recipient and a provider where communication occurs to mutually agree upon details of need description, service to be rendered, price, terms of payment, etc in order establish a contract.

Rating: A rating is a score and (optional) comment (review) submitted by a recipient or provider for a particular transaction which describes the level of satisfaction (or lack thereof). For each transaction, a rating may be submitted separately by both the recipient and provider.

Provider: A member, group, business or non-profit that offers goods or services in a transaction.

Skill: A skill is a collection of information (i.e., name, description) used to describe what product or service a member 201 is capable of rendering as a provider. A talent, expertise, or ability, defined by a member in their profile, which can be made available to other members for bartering, volunteering, or fundraising transactions.

Good: A tangible product that is made available through the system.

Need: A request for goods or services, defined by a member, whether for bartering, volunteering, or fundraising.

Job: A posting for a specific need for which a recipient is willing to pay barter currency, or for which volunteer activity is requested.

Transaction: An event that occurs between a recipient and a provider where goods are provided or services are rendered.

Wallet: A wallet is the term used to describe a member's barter currency account.

Individual—An person, whether unauthenticated visitor or member, who interfaces with the system.

Group—Several members who, together, function as a single provider or recipient within the system.

Business—A member context created in the name of a business rather than a natural person.

Non-Profit—An authenticated account that was created in the name of a non-profit organization.

Financial Institution—A strategic partner that interfaces with the system who can be permitted to exchange normal currency for barter currency and/or maintain balance information for members, and share in revenue streams, based on various types of activity. A Financial Institution may also refer to a member's associated credit card issuing institution or bank.

A transaction.

Volunteer Points—Provide a credits system of measurement for value provided through volunteer transactions. Provides the ability to attribute different levels of value to volunteer time, according to community-defined practices and agreements.

Barter Currency—Provide a means of facilitating asynchronous barter transactions, both in terms of time and relationship.

Community—A realm that defines the scope of permitted transaction activity. There are 4 types of communities:

1. Location-based Communities—These are local communities that serve as the primary boundary of the barter transactions and volunteer activity in the system. (e.g. State College, York)

2. Communities of Practice—Facilitate transactions across communities of practice (e.g. dentists, CPAs)

3. Organizational Communities—Facilitate transactions within traditional organizations and businesses (e.g. Penn State, IBM)

4. Interest-based Communities—Establishes social communities based on defined interests, hobbies, etc. (e.g. antique collecting, hiking)

Interest—A hobby, pastime, or activity that multiple members may have in common. Interests form the basis for “communities of interest” which can be leveraged for transactions by members.

Affiliations (organizational and professional)—Establishes connections for professional and organizational relationships.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for implementing an exchange of goods and services through barter currency and volunteer transactions over a distributed computer network, the system comprising:
a service bus in data communication with a barter currency module, a transaction brokering module, a search engine module, a discovery module, and a database, the system configured to process barter currency transactions and volunteer transactions;
wherein:
the barter currency module is configured to compute transaction fees, access financial accounts metadata, access currency distribution metadata, communicate computation data through the service bus,
the barter currency module comprising:
a computation module to send and retrieve data from a financial accounting metadata database and a currency distribution metadata database.

2. The system of claim 1, wherein the currency distribution metadata database comprises data and metadata for calculating allocated and distributed amounts for transferring barter currency.

3. The system of claim 1, wherein the service bus is further connected in data communication with a plurality of engines.

4. The system of claim 3, wherein the plurality of engines comprises a brokering engine, a search engine and a discovery engine.

5. The system of claim 4, wherein the brokering engine is configured to implement a functionality to execute a plurality of asynchronous transactions within the system.

6. The system of claim 5, wherein the search engine and the discovery engine exchange data with the community database, wherein the community database stores data and metadata associated with communities.

7. The system of claim 6, wherein the metadata associated with communities comprises metadata associated with individuals, businesses and organizations, relationships between the individuals and organizations, and communities associated with individuals, businesses and organizations.

8. The system of claim 1, further comprising a geolocation module, the geolocation module in data communication with the service bus, the geolocation module configured to provide location-based information relating to geography.

9. The system of claim 1, further comprising a volunteer transaction module configured to process transactions between at least one provider and at least one recipient, record volunteer credits associated with providers, and provide information related to needs posted by recipients.

10. The system of claim 1, wherein the service bus further comprises a processor, a memory module, and a network interface for communicating with at least one remote communications device, for communicating data between the service bus and the remote communications device, each remote communications device securely associated with at least one participating individual.

11. A computer-implemented method for executing an exchange of goods and services through an asynchronous barter currency and volunteer transaction comprising:
accessing a distributed data network system for communicating transaction data between a plurality of members;
purchasing a barter currency and establishing a credit to a purchaser's account in the system;
creating a need posting, the need posting comprising at least a description of a service requested for purchase and an initial price; and
engaging a provider through the network system to perform the service described in the need posting.

12. The method of claim 11, further comprising negotiating between a prospective provider and a recipient to iteratively arrive at a set of mutually agreed transaction terms.

13. The system of claim 11, wherein at least one provider and at least one recipient aggregate multiple negotiated transactions to support of a cause, whereby the providers agree to defer payment to the cause.

14. The method of claim 11, further comprising searching one or more need postings to identify a need posting including a request for a service or good by a member provider possessing the service or goods requested;

15. The method of claim 11, further comprising responding to a need posting or inquiring of a provider to request goods and services.

16. The method of claim 11, further comprising negotiating a transaction, the transaction including a barter currency payment from the purchaser to a provider.

17. The method of claim 16, further comprising transferring a negotiated barter currency amount from a purchaser account to an escrow provider account.

18. The method of claim 11, further comprising communicating need posting information to the system as a provider performs a need associated with the need posting.

19. The method of claim 11, further comprising Identifying a status of the need as completion pending.

20. A system for establishing reputation and trust for barter and volunteer activities over a distributed computer network, the system comprising:
a server including a processor, a memory module, a storage medium, a network interface, and a plurality of remote communications devices for communicating data between the server and one or more of the plurality of remote communications devices, each of the remote communications devices securely associated with at least one participating individual;
the system further comprising a communications processing module, a barter currency module, a geolocation module, a transaction brokering module, a search engine module, a discovery module, and a database, the system configured to process barter currency transactions and volunteer transactions;
the system configured to enable one or more individuals to:
access a distributed data network system and communicate transaction data between a plurality of members;
purchase a barter currency and establish a credit to a purchaser's account in the system;
create a need posting comprising at least a description of a service requested for purchase and an initial price; and
engage a provider through the network system to perform the service described in the need posting.
